(19) United States
(12) Patent Application Publication
(10) Pub. No.: US 2017/0220252 A1
(43) Pub. Date: Aug. 3, 2017

(54) FLASH EMULATED EEPROM WRAPPER

(71) Applicant: Faraday&Future Inc., Gardena, CA (US)

(72) Inventors: Richard Edward SLINDEE, Los Angeles, CA (US); Jana Mahen FERNANDO, Torrance, CA (US)

(21) Appl. No.: 15/199,844

(22) Filed: Jun. 30, 2016

Related U.S. Application Data
(60) Provisional application No. 62/288,938, filed on Jan. 29, 2016.

(51) Int. Cl. G06F 3/06; G06F 12/02

(52) U.S. Cl. CPC G06F 3/061; G06F 3/0619; G06F 3/0647; G06F 3/0659; G06F 3/0673; G06F 12/0292; G06F 2212/1016; G06F 2212/1032; G06F 2212/173

(57) ABSTRACT

This relates to a file system, and more particularly to, a file system compatible with multiple types of non-volatile memory for safety-critical embedded systems, such as an Electronic Control Unit (ECU) of an automobile. Some examples of the disclosure include an ECU having RAM and non-volatile memory managed by a file system. In some examples, non-volatile memory can include a flash-emulated EEPROM (FEE) device. A wrapper function can provide an interface between a file system and one or more hardware devices, allowing the file system and application code to be compatible with multiple kinds of hardware.

### CROSS REFERENCE TO RELATED APPLICATION

This application claims priority to U.S. Provisional Patent Application No. 62/288,938, filed Jan. 29, 2016, the content of which is incorporated by reference herein in its entirety for all purposes.

### FIELD OF THE DISCLOSURE

This relates to a file system, and more particularly to, a file system compatible with multiple types of non-volatile memory for safety-critical embedded systems, such as an Electronic Control Unit (ECU) of an automobile.

### BACKGROUND OF THE DISCLOSURE

Embedded systems can feature random access memory (RAM), non-volatile memory, and other types of memory and storage within a memory hierarchy. RAM can provide fast performance but can require a connected power supply to retain data. Non-volatile memory, however, can retain data when the power supply is disconnected. Examples of non-volatile memory include, but are not limited to, Electrically Erasable Programmable Read-Only Memory (EEPROM), battery-backed RAM, and flash, including flash-emulated EEPROM (FEE). To create a system that can function quickly and retain data when the power supply is disconnected, data can be stored in non-volatile memory and loaded into RAM when it is needed to execute a function. When RAM data is modified, it can later be saved to non-volatile memory to be available in the event of loss of power. When data is saved to RAM or non-volatile memory, it can be accessed by a function that knows the address where the data is saved.

The non-volatile memory in many embedded systems can be managed manually within application code or by a file system. When non-volatile memory is managed by application code, developers can agree on which addresses in non-volatile memory to allocate to each data structure. Managing the address of each structure prevents data from being inadvertently overwritten or lost. Manually allocating and tracking the contents of each level of a memory hierarchy can be error-prone and tedious. File systems, however, can automatically manage memory on multiple levels and provide other features, described below for example, to alleviate several disadvantages of manual memory management.

File systems can allocate space for data in multiple levels of a memory hierarchy within a computer system and maintain a record of where each structure is located. Other features of file systems include, but are not limited to, multi-level directories and the use of security credentials. These file systems are advantageous to computer systems—including, but not limited to, mobile devices, laptops, and other consumer electronics—with many files, high-level functions, and/or sensitive data. Electronic Control Units (ECUs) within consumer automobiles, however, generally run low-level, safety-critical applications. Therefore, many features of contemporary file systems are unnecessary for managing memory within an ECU. Furthermore, multiple kinds of memory devices can be included in a single vehicle, thus necessitating special functionality of one or more filesystems for use in a vehicular file system. For example, different kinds of FEE devices can be used across different ECUs, each FEE device requiring a library of function calls to achieve EEPROM behavior. Thus, there exists a need in the field of ECUs for a file system tailored to automotive control sequences and ECU hardware, which can vary across ECUs incorporated into a single automobile.

### SUMMARY OF THE DISCLOSURE

This relates to a file system and, more particularly, to a file system compatible with multiple types of non-volatile memory for safety-critical embedded systems, such as an Electronic Control Unit (ECU) of an automobile. Some examples of the disclosure include an ECU having RAM and non-volatile memory managed by a file system. Contemporary file systems can be designed to work with specific hardware implementations of non-volatile memory such as, for example, EEPROM, flash, battery-backed RAM, or other types of non-volatile memory. In some examples of ECUs, the hardware used for non-volatile memory may be unknown at the start of software development or may be inconsistent between ECUs incorporated into a line of vehicles or even within a single vehicle, for example. This inconsistency can make it difficult for a team of developers to select a file system for an ECU and make it even more difficult to manually manage the non-volatile memory within application code. Furthermore, some examples of file systems can dynamically allocate memory. In safety-critical systems such as an ECU, it can be advantageous to only save data when there is sufficient time to complete the save operation to avoid loss of critical information, for example. In some examples, an ECU can include a hardware-independent file system designed for safety-critical systems.

In some examples, an ECU can use a file system to manage RAM and non-volatile memory. In some examples, a file system can provide software developers with hardware-independent functions for using the file system in code to be executed by the ECU. A hardware-independent file system according to examples of the disclosure can provide a layer of abstraction so developers may not need to tailor their code to the type of non-volatile memory the ECU uses. According to some examples of the disclosure, the file system can include a table of contents having an array of entries. The array of entries can record and track one or more data structures that may be stored in RAM and/or non-volatile memory of an ECU, for example. The array can include, for each entry, a unique ID, its address in RAM and non-volatile memory, its size, and metadata. The metadata can include, for example, a version number, a time the entry was last saved to non-volatile memory, and other information according to examples of the disclosure. When the ECU is powered on, the table of contents can be loaded from non-volatile memory into RAM. Before powering off, the ECU can save the table of contents to non-volatile memory when it is safe to do so. In some examples, data can be saved to non-volatile memory in situations where there is enough time to complete the process of saving without interruption to prevent data corruption, making the ECU more reliable. Furthermore, one or more wrapper functions can be provided to asynchronously execute read/write operations, creating an additional layer of compatibility and protection from inadvertent data loss.

### BRIEF DESCRIPTION OF THE DRAWINGS

FIG. 1 illustrates an exemplary memory hierarchy according to examples of the disclosure.

FIG. 2 illustrates an exemplary computing system according to examples of the disclosure.

FIG. 3 illustrates an exemplary computing system including a file system according to examples of the disclosure.

FIG. 4 illustrates a block diagram of exemplary computing system hardware managed by a file system according to examples of the disclosure.

FIG. 5 illustrates an exemplary process for initiating a file system and loading or generating a table of contents for the file system, according to examples of the disclosure.

FIG. 6 illustrates an exemplary process for managing a data structure including registering an entry, saving an entry, and retrieving an entry using a file system, according to examples of the disclosure.

FIG. 7 illustrates an exemplary process for saving all entries and saving the table of contents to non-volatile memory using a file system, according to examples of the disclosure.

FIG. 8 illustrates an exemplary computing system including a file system and a wrapper function according to examples of the disclosure.

FIG. 9 illustrates an exemplary block diagram of computer hardware with a file system in communication with a FEE wrapper function according to examples of the disclosure.

FIG. 10 illustrates an exemplary process for initiating a file system and loading or generating a table of contents for the file system, according to examples of the disclosure.

FIG. 11 illustrates an exemplary process for managing a data structure including registering an entry, saving an entry, and retrieving an entry using a file system, according to examples of the disclosure.

FIG. 12 illustrates an exemplary process for saving all entries and the table of contents to non-volatile storage using a file system, according to examples of the disclosure.

FIGS. 13A-13C illustrate exemplary processes of storing data using a wrapper function according to examples of the disclosure.

FIG. 14 illustrates a block diagram of an exemplary vehicle including a plurality of ECUs according to examples of the disclosure.

### DETAILED DESCRIPTION

In the following description, reference is made to the accompanying drawings which form a part hereof, and in which it is shown by way of illustration specific examples that can be practiced. It is to be understood that other examples can be used and structural changes can be made without departing from the scope of the examples of the disclosure.

Embedded systems can feature random access memory (RAM), non-volatile memory, and other types of memory and storage within a memory hierarchy. RAM can provide fast performance but can require a connected power supply to retain data. Non-volatile memory, however, can retain data when the power supply is disconnected. Examples of non-volatile memory include, but are not limited to, Electrically Erasable Programmable Read-Only Memory (EEPROM), battery-backed RAM, and flash, including flash-emulated EEPROM (FEE). To create a system that can function quickly and retain data when the power supply is disconnected, data can be stored in non-volatile memory and loaded into RAM when it is needed to execute a function. When RAM data is modified, it can later be saved to non-volatile memory to be available in the event of loss of power. When data is saved to RAM or non-volatile memory, it can be accessed by a function that knows the address where the data is saved.

The non-volatile memory in many embedded systems can be managed manually within application code or by a file system. When non-volatile memory is managed by application code, developers can agree on which addresses in non-volatile memory to allocate to each data structure. Managing the address of each structure prevents data from being inadvertently overwritten or lost. Manually allocating and tracking the contents of each level of a memory hierarchy can be error-prone and tedious. File systems, however, can automatically manage memory on multiple levels and provide other features, described below for example, to alleviate several disadvantages of manual memory management.

File systems can allocate space for data in multiple levels of a memory hierarchy within a computer system and maintain a record of where each structure is located. Other features of file systems include, but are not limited to, multi-level directories and the use of security credentials. These file systems are advantageous to computer systems—including, but not limited to, mobile devices, laptops, and other consumer electronics—with many files, high-level functions, and/or sensitive data. Electronic Control Units (ECUs) within consumer automobiles, however, generally run low-level, safety-critical applications. Therefore, many features of contemporary file systems are unnecessary for managing memory within an ECU. Furthermore, multiple kinds of memory devices can be included in a single vehicle, thus necessitating special functionality of one or more filesystems for use in a vehicular file system. For example, different kinds of FEE devices can be used across different ECUs, each FEE device requiring a library of function calls to achieve EEPROM behavior. Thus, there exists a need in the field of ECUs for a file system tailored to automotive control sequences and ECU hardware, which can vary across ECUs incorporated into a single automobile.

This relates to a file system and, more particularly, to a file system compatible with multiple types of non-volatile memory for safety-critical embedded systems, such as an Electronic Control Unit (ECU) of an automobile. Some examples of the disclosure include an ECU having RAM and non-volatile memory managed by a file system. Contemporary file systems can be designed to work with specific hardware implementations of non-volatile memory such as, for example, EEPROM, flash, battery-backed RAM, or other types of non-volatile memory. In some examples of ECUs, the hardware used for non-volatile memory may be unknown at the start of software development or may be inconsistent between ECUs incorporated into a line of vehicles or even within a single vehicle, for example. This inconsistency can make it difficult for a team of developers to select a file system for an ECU and make it even more difficult to manually manage the non-volatile memory within application code. Furthermore, some examples of file systems can dynamically allocate memory. In safety-critical systems such as an ECU, it can be advantageous to only save data when there is sufficient time to complete the save operation to avoid loss of critical information, for example. In some examples, an ECU can include a hardware-independent file system designed for safety-critical systems.

In some examples, an ECU can use a file system to manage RAM and non-volatile memory. In some examples, a file system can provide software developers with hardware-independent functions for using the file system in code to be executed by the ECU. A hardware-independent file system according to examples of the disclosure can provide a layer of abstraction so developers may not need to tailor their code to the type of non-volatile memory the ECU uses. According to some examples of the disclosure, the file system can include a table of contents having an array of entries. The array of entries can record and track one or more data structures that may be stored in RAM and/or non-volatile memory of an ECU, for example. The array can include, for each entry, a unique ID, its address in RAM and non-volatile memory, its size, and metadata. The metadata can include, for example, a version number, a time the entry was last saved to non-volatile memory, and other information according to examples of the disclosure. When the ECU is powered on, the table of contents can be loaded from non-volatile memory into RAM. Before powering off, the ECU can save the table of contents to non-volatile memory when it is safe to do so. In some examples, data can be saved to non-volatile memory in situations where there is enough time to complete the process of saving without interruption to prevent data corruption, making the ECU more reliable. Furthermore, one or more wrapper functions can be provided to asynchronously execute read/write operations, creating an additional layer of compatibility and protection from inadvertent data loss.

Other features of file systems include, but are not limited to, multi-level directories and the use of security credentials. These file systems are advantageous to systems with many files, high-level functions, and/or sensitive data, for example. In some examples, file systems are designed to work with a particular type of hardware for each level of memory.

Electronic Control Units (ECUs) within consumer automobiles, however, generally run low-level, safety-critical applications, for example. Therefore, according to some examples of the disclosure, many features of contemporary file systems may be unnecessary for managing memory within an ECU. Furthermore, in some examples, contemporary file systems can be hardware-dependent. When, for example, the one or more types of hardware for non-volatile memory can vary from project-to-project or may not be agreed on at the start of a project, memory management can be challenging for developers because different types of non-volatile memory can operate in different ways. In particular, a first FEE device can use a first library for emulating EEPROM behavior while a second FEE device can respectively use a second library for emulating EEPROM behavior. File systems according to examples of the disclosure can include hardware-independent functions for developers to use when writing software for ECUs. In some examples, a file system itself can be hardware-independent. A wrapper function can be included to receive one or more hardware-independent function calls from a file system and to interface with one or more devices of a computing system.

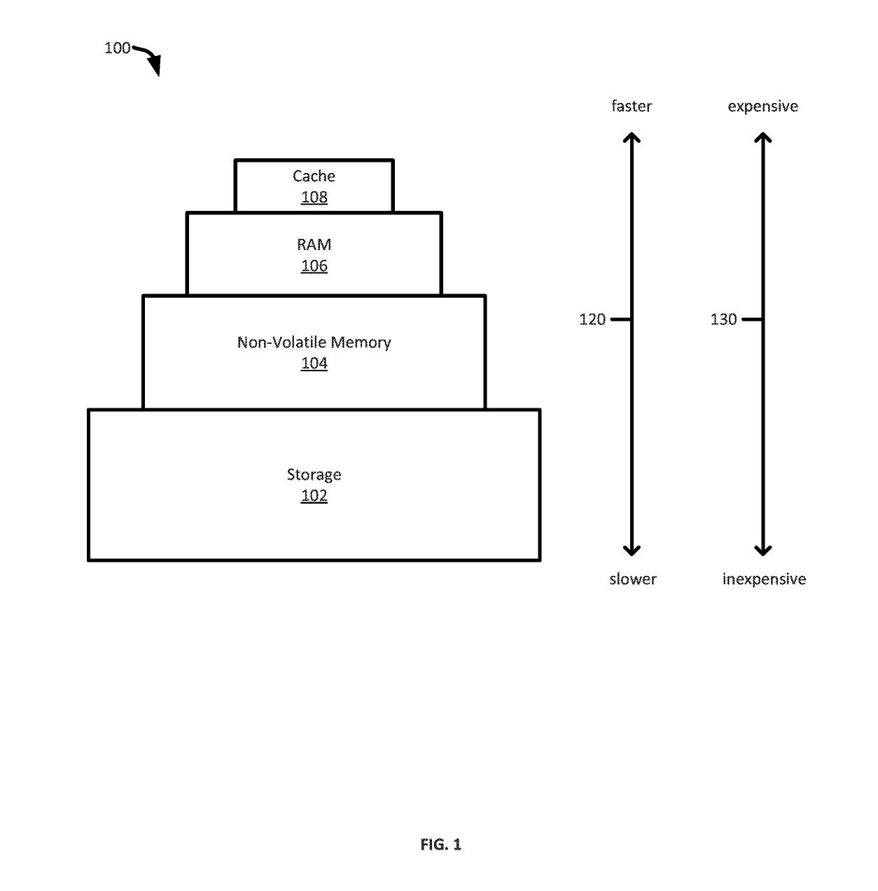

File systems and associated wrapper functions can be used in computing systems such as embedded systems, consumer electronics, and computers to manage data stored thereon, according to examples of the disclosure. A computing system can include multiple levels of memory, such as volatile memory (e.g., random access memory (RAM)) and non-volatile memory, for example. Each level can have tradeoffs associated therewith. FIG. 1 illustrates an exemplary memory hierarchy 100 according to examples of the disclosure. The memory hierarchy 100 can include multiple levels of memory with associated tradeoffs such as speed 120 and cost 130, for example. In some examples, the memory hierarchy 100 includes storage 102, non-volatile memory 104, RAM 106, and a cache 108. Storage 102 can be implemented in a hard drive, for example. Non-volatile memory 104 can be implemented in an EEPROM, battery-backed RAM, or flash (including, e.g., one or more FEE devices), for example. Other implementations of storage 102 and non-volatile memory 106 are possible. Other exemplary computer systems may have more or fewer levels within a memory hierarchy as appropriate for the computer system. Some ECUs can have a memory hierarchy including RAM and non-volatile memory, for example.

In the example of FIG. 1, the cache 108 is the fastest and most expensive level of memory in the hierarchy 100 and storage 102 is the slowest and least expensive. As such, an exemplary computer system having example memory hierarchy 100 can have the least amount of space in the cache 108 and the most amount of space in storage 102, for example. By having less space in faster, expensive memory and more space in slower, inexpensive memory, a computing system can perform at high speeds when necessary without including excessively large amounts of expensive, high-speed memory.

Furthermore, in some examples, volatile levels of the memory hierarchy, such as the cache 108 and RAM 106 may only retain data while a system power supply (not shown) is connected. Other levels of the memory hierarchy 100, such as non-volatile memory 104 and storage 102 can retain data while a system power supply is disconnected. Therefore, having multiple levels of memory can, for example, allow a computer system to retain data when powered off in addition to the other tradeoffs discussed above.

To make effective use of its memory hierarchy, a computer system may move data between hierarchy levels during operation, for example. In some examples, when a computer system is executing an application or modifying a file, it can be advantageous for that data to reside on high-speed, high-cost memory such as the cache 108. When the computer has finished modifying data, the data can be saved to a slower, less expensive level of memory, such as non-volatile memory 104 or storage 102, for example. In some examples, saving data not currently in use to non-volatile memory 104 or storage 102 can make room in the cache 108 and in RAM 106 for other data and can secure it in the event of a power outage. For simple memory hierarchies, such as those including only RAM and non-volatile memory, for example, developers can manually track which addresses in each level of memory a data structure is to be saved. Keeping a record of where each data structure can be saved in each level of memory can help a team of developers avoid inadvertently overwriting or losing track of data, for example.

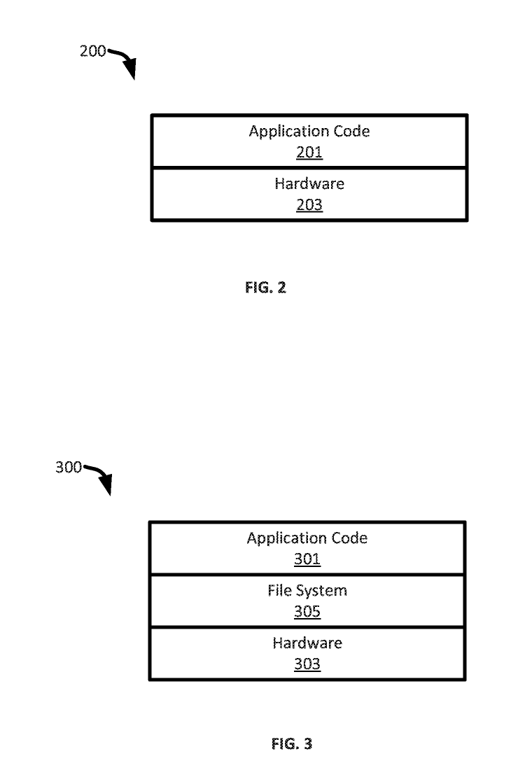

In some examples, as mentioned above, one or more software developers can manually track each data structure included in application code in a memory hierarchy of a computing system. FIG. 2 illustrates an exemplary computing system 200 according to examples of the disclosure. Computing system 200 can include application code 201 interfacing directly with computer hardware 203.

When application code 201 interfaces directly with hardware 203, one or more developers working on application code 201 can ensure a location in hardware 203 of each data structure used in application code 201 is documented and tracked. To reliably manage memory, storage, and other registers of hardware 203, the one or more developers may write application code 201 to specifically interact with the type(s) of devices included in hardware 203. For example, when writing application code 201 for hardware 203 including a FEE device, the one or more developers can call one or more functions of a respective library provided with the FEE device to properly use it. Accordingly, one or more developers may know which specific device(s) are in use in hardware 203 prior to writing application code 201.

Because application code 201 interfaces directly with hardware 203, every developer writing software for computing system 200 may need to know what kinds of devices are in use in hardware 203 and/or which addresses of one or more devices can be used for each data structure. In some examples, as memory hierarchies become more complex, as developer teams grow, or as development moves at faster speeds, manually tracking the location of each data structure can become error-prone and tedious. Furthermore, to manually manage non-volatile memory, developers may need to know one or more specific types of hardware the computer system will use and how to manage its memory, for example. Therefore, in some examples, it can be advantageous to further include a file system to interface between application code and hardware of a computing system.

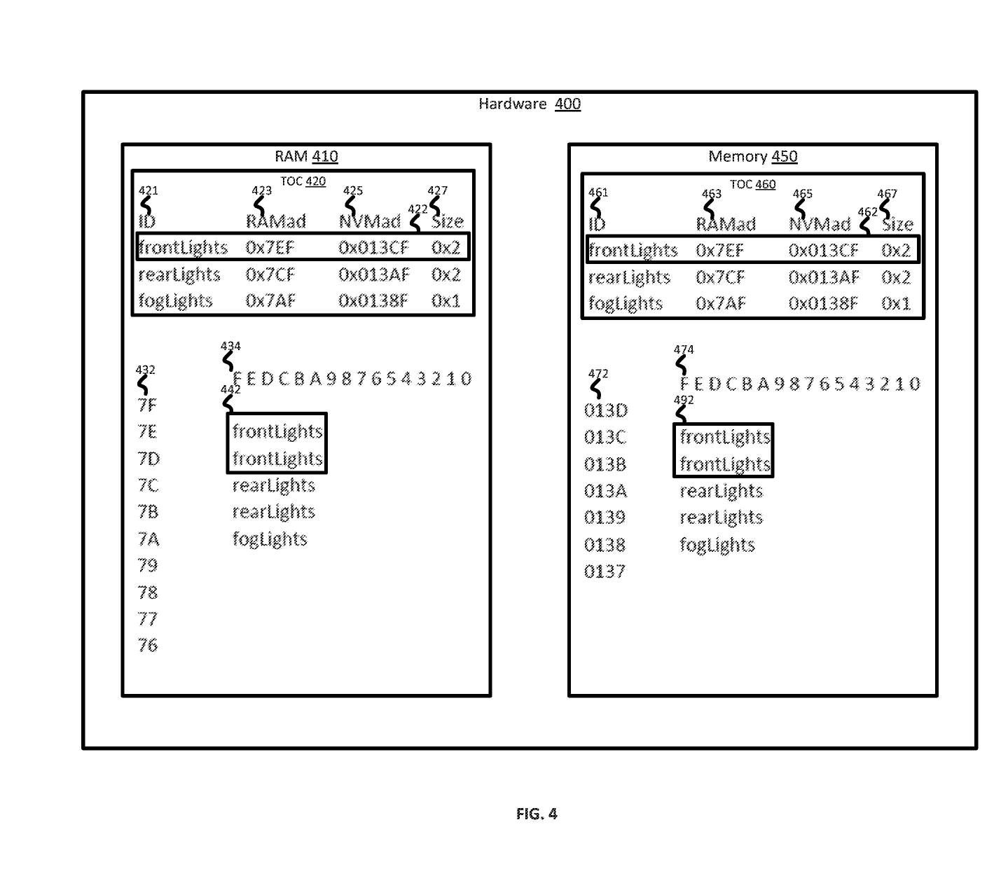

As mentioned above, a computing system according to examples of the disclosure can further include a file system to manage memory at multiple levels, for example. FIG. 3 illustrates an exemplary computing system 300 including a file system 305 according to examples of the disclosure. Computing system 300 can include application code 301, file system 305, and hardware 303.

In some examples, file system 305 can allocate space in multiple levels of a memory hierarchy included in hardware 303 within a system and maintain a record of where each data structure included in application code 301 is located. In this way, application code 301 can make one or more memory—and/or storage—management function calls to file system 305, as opposed to interacting with one or more devices included in hardware 303 directly. File system 305 can ensure each data structure is stored in a documented location for reliable retention and retrieval in response to receiving the above function calls.

In some examples, a computing system (e.g., an ECU included in a vehicle) can include RAM and non-volatile memory managed by a file system. FIG. 4 illustrates a block diagram of exemplary computing system hardware 400 managed by a file system according to examples of the disclosure. Hardware 400 can include RAM 410 and non-volatile memory 450, each with data 442 and 492 stored thereon, according to examples of the disclosure.

Data in RAM 410 can be addressed by byte number 432 and bit number 434, for example. Data in non-volatile memory 450 can be addressed by byte number 472 and bit number 474, for example. In some examples, RAM 410 can be faster and more expensive than non-volatile memory 450. Non-volatile memory 450 can retain data even when the power supply (not pictured) to the hardware 400 is disconnected, for example. Non-volatile memory 450 can include EEPROM (including, e.g., a FEE device), flash, battery-backed RAM or other types of non-volatile memory, according to examples of the disclosure. In some examples, a file system can keep track of a location of each data structure used in application code in each level of a memory hierarchy (e.g., RAM 410 and Memory 450). A file system can include hardware-agnostic functions for developers to call to use the file system to save, load, and/or move one or more data structures, allowing the application code to perform these functions with a variety of non-volatile memory types. Because RAM 410 and non-volatile memory 450 can have different advantages and disadvantages, hardware 400 can use both levels of memory to have fast performance and inexpensive memory capable of saving data without a connected power supply.

As mentioned above, according to some examples of the disclosure, a computing system including hardware 400 can use a file system capable of managing data in RAM 410 and non-volatile memory 450. The file system can include a table of contents, of which there may be a copy 420 saved in RAM 410 and/or a copy 460 saved in non-volatile memory 450. When the table of contents 420 stored in RAM 410 is updated, as will be described below, and then saved to non-volatile memory 450, both copies 420 and 460 can be identical. The table of contents 420 stored in RAM 410 can include entries, such as entry 422, that indicate where each data structure of the ECU is stored in RAM 410 and non-volatile memory 450, which will be described in more detail below. Likewise, for example, the table of contents 460 stored in non-volatile memory 460 of hardware 400 can include respective entry 462.

Entry 422 in table of contents 420 can include a unique ID 421, an address 423 of the data structure in RAM 410, an address 425 of the data structure in non-volatile memory 450, and the size 427 of the data structure, for example. Likewise, for example, entry 462 in table of contents 460 can include a unique ID 461, an address 463 of the data structure in RAM 410, an address 465 of the data structure in non-volatile memory 450, and the size 467 of the data structure. As shown in FIG. 4, for example, “frontLights” is stored at address 0x7EF in RAM 410 and address 0x013CF in non-volatile memory 450. These addresses are reflected in entry 422 in table of contents 410 and entry 462 in table of contents 460. Some example tables of contents may also include metadata (not pictured) for each entry. The metadata can include a version number and a time indicating when the entry was last saved to non-volatile memory. Some examples of the disclosure may, additionally or alternatively, have other kinds of metadata for each entry within a table of contents.

In some examples, a table of contents, such as table of contents 420 or table of contents 460 for example, can also include its own metadata (not pictured). This metadata can include an ID to indicate a location of the table of contents in non-volatile memory, a version indicating the structure of the table of contents, a time indicating when the table of contents was created, and a time indicating when the table of contents was last saved to non-volatile memory. Some examples of the disclosure may, additionally or alternatively, have other kinds of metadata for a table of contents.

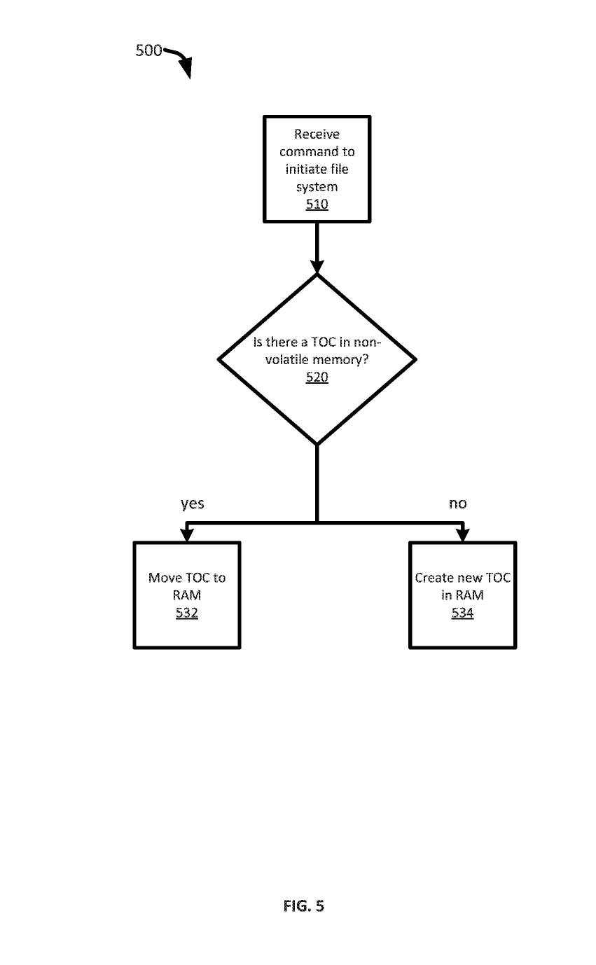

A file system according to examples of the disclosure can automatically manage where in RAM and non-volatile memory to save a data structure once that data structure is initiated. FIG. 5 illustrates an exemplary process 500 for initiating a file system and loading or generating a table of contents for the file system, according to examples of the disclosure. An application stored on a computing system can execute a command to initiate a file system (e.g., the command can originate in application code). Once the command is received 510 at the file system, the computing system can check 520 non-volatile memory for an existing table of contents (e.g., table of contents 460), for example. In some examples, a table of contents 460 and its entries may have been saved to non-volatile memory before the ECU power was disconnected. In some examples, if a table of contents 460 is found in non-volatile memory, it can be moved 532 to RAM. In some examples, if no table of contents is found, a new table of contents 420 can be created 534 in RAM. Once the table of contents (e.g., table of contents 460 stored in memory 450 or table of contents 420 stored in RAM 410) is moved 532 to, or created 534 in, RAM 410, it can be read and edited by the computing system to manage data, according to examples of the disclosure.

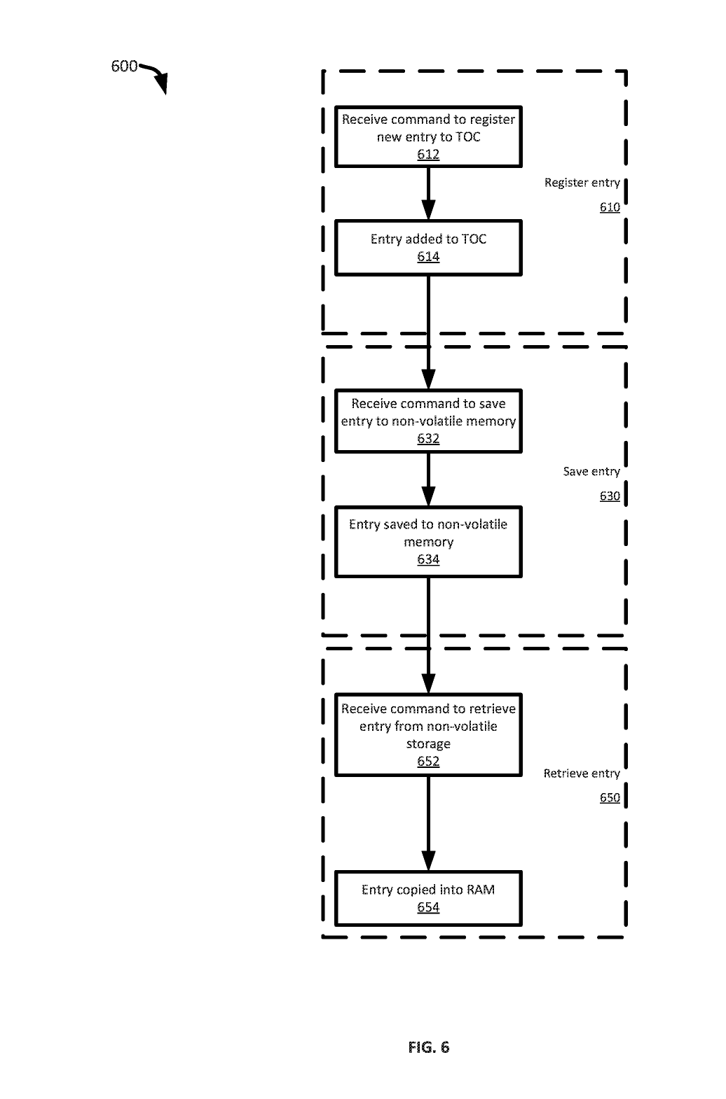

In some examples, once a table of contents 420 is stored in RAM, the computing system can use the file system to manage data. FIG. 6 illustrates an exemplary process 600 for managing a data structure including registering an entry 610, saving an entry 630, and retrieving an entry 650 using a file system, according to examples of the disclosure. For data to be managed by the file system, it can be registered 610 with a table of contents, for example.

In some examples, registering 610 an entry can include storing an ID 421 or 461 of the data structure, its size 427 or 467, and its address in RAM 423 or 463 and/or its address in memory 425 or 465 in a table of contents 420 or 460. In some examples, an application executed by the computing system can include a command to register an entry. The command can include a unique ID 421 or 461 for the entry, the size 427 or 467 of the data structure, and a version number (not shown), for example. When the command is received 612 at the file system, the entry can be added to the table of contents 614 and managed by the file system according to examples of the disclosure.

In some examples, space in RAM 410 and non-volatile memory 450 can be allocated for each entry at the time it is registered. In other examples, space in RAM 410 and non-volatile memory 450 can be dynamically allocated as needed. In some examples, when an entry is registered to the table of contents 420 or 460, the entry may not include an address in non-volatile memory 450 until the application code executes a command to save the corresponding data structure, as described below. Additionally or alternatively, in some examples, data stored in non-volatile memory 450 may not have a RAM address 423 or 463 associated therewith until it is loaded from non-volatile memory 450, as described below. Examples of saving and loading data with a file system according to examples of the disclosure will now be described.

In some examples, after registering entries, as described above, the file system can save 630 registered entries to non-volatile memory 450. Saving data to non-volatile memory 450, as discussed above, can have the advantages of protecting it in the event of a power outage and/or creating more space in RAM 410 for data that may need to be edited, for example. An application executed by the computing system according to examples of the disclosure can modify data associated with a registered entry and then execute a command to save it to non-volatile memory 450. Once the command is received 632 at the file system, the data can be saved 634 to non-volatile memory 450, for example. In some examples, an entry may have space allocated for it in non-volatile memory when it is registered. That is, there may be space in non-volatile memory 450 allocated for data that has not yet been saved to non-volatile memory 450, for example. In some examples, an entry may not have space allocated for it in non-volatile memory 450 when it is registered. That is, an entry's address 425 or 465 in non-volatile memory 450 may not be included in the table of contents 420 or 460 until the entry has been saved to non-volatile memory 450, for example.

In some examples, once an entry is registered 610 with the table of contents 420 or 460 and saved 630 to non-volatile memory 450, it can be retrieved 650 from non-volatile memory 450 and loaded into RAM 410. Loading data into RAM 410, as discussed above, can have the advantages of quick access and editing, for example. In some examples, an application executed by the computing system can retrieve data to be edited or otherwise used by the computing system by executing a command. Once the command is received 652, the data can be copied into RAM 654, for example. In some examples, an address in RAM may be allocated for data before a command to retrieve the entry's data is received at the file system. That is, the table of contents 420 or 460 may already include an assigned address 423 in RAM for an entry before it is retrieved, for example. In some examples, an address 423 in RAM may be allocated for an entry when a command to retrieve the entry's data is received at the file system. That is, an entry's address 423 in RAM may not be included in the table of contents 410 or 460 until the entry's data has been loaded into RAM 410, for example. According to examples of the disclosure, an entry's data can be retrieved as long as the entry is registered to the table of contents 420 or 460 and its data is saved to non-volatile memory 450. For example, if a computing system has not saved or otherwise edited data using its RAM 410 since powering on, it can access data saved to non-volatile memory 450 during a previous use by retrieving it from non-volatile memory 450.

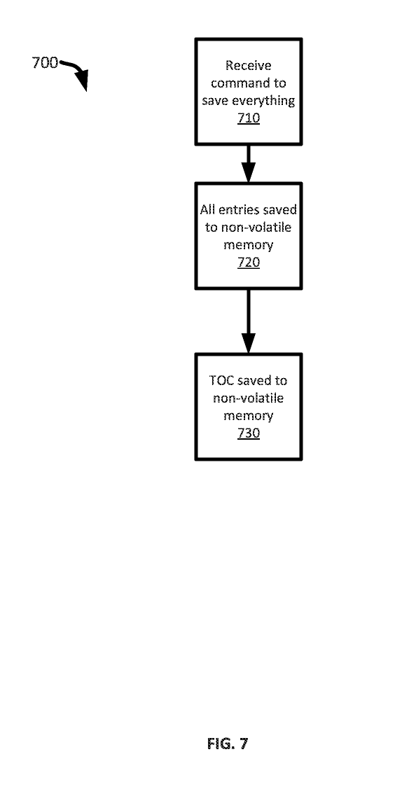

In some examples, when data is being saved to non-volatile memory 450, an interruption such as a power outage or other error can corrupt the data. In a safety-critical system such as a vehicle ECU, it may be important for saves only to occur when there is enough time to reliably complete the process uninterrupted, for example. Therefore, some examples of the disclosure only save data to non-volatile memory 450 when a command to save is received from the user or when the system otherwise detects there is sufficient time to fully execute the save. In some examples, to preserve the table of contents 420 and all data currently stored in RAM 420, everything can be saved to non-volatile memory 450 before the power supply (not shown) is disconnected. FIG. 7 illustrates an exemplary process 700 for saving 720 all entries and saving 730 the table of contents 420 to non-volatile memory 450 using a file system, according to examples of the disclosure. The computing system can receive a command to save everything 710, for example. Then, all entries can be saved 720 to non-volatile memory and the table of contents 420 can be saved 730 to non-volatile memory 450, for example.

In some examples, steps 720 and 730 may be performed in any order or concurrently according to various examples of the disclosure. In some examples, a command to save everything can be sent to the file system automatically in response to a user command to disconnect or turn off a power supply of the computing system. For example, a user may input a command to turn off a vehicle including one or more ECUs including a computing system according to the examples described above.

Although a file system according to FIGS. 3-7 can provide a layer of abstraction between application code and device hardware, the file system itself may need to be tailored to one or more specific devices incorporated into a computing system on which it operates. For example, to perform a save or load operation according to the examples described above, the source code of a file system may need to make one or more function calls to an EEPROM-emulating library of a FEE device incorporated into a computing system. Just as it can be inconvenient for a team of developers working on application code to use device-specific function calls to manage memory, it can be inconvenient for a team of developers maintaining a file system's source code to do the same. Therefore, in some examples, it can be advantageous to further include a FEE wrapper function to provide a standardized, predictable interface between a file system and device hardware.

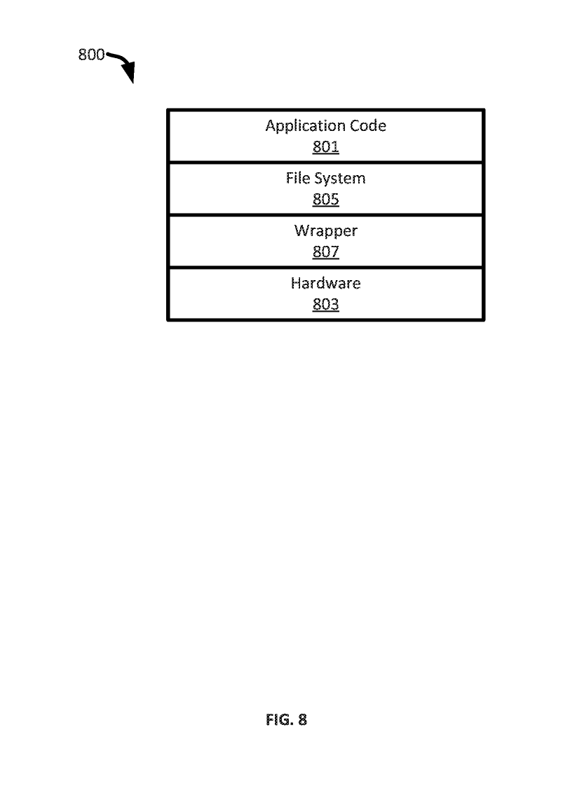

In some examples, a FEE device can be a flash-based device with memory addressable in blocks configured to emulate the individually-addressable byte behavior of an EEPROM. Several types of FEE devices are available, each with different libraries for accessing EEPROM-like behavior of the device. A FEE wrapper function can allow a file system to issue EEPROM-style commands that will be compatible with a plurality of FEE devices, allowing developers of application code and of the file system itself to write their source code independent of the type of hardware that will be used in a computing system. FIG. 8 illustrates an exemplary computing system 800 including a file system 805 and a wrapper function 807 according to examples of the disclosure. Computing system 800 can include application code 801, file system 805, wrapper function 807, and hardware 803.

In some examples, file system 805 can allocate space in multiple levels of a memory hierarchy included in hardware 803 within a system and maintain a record of where each data structure included in application code 801 is located. In this way, application code 801 can make one or more memory—and/or storage—management function calls to file system 805, as opposed to interacting with one or more devices included in hardware 803 directly. In turn, file system 805 can manage data stored on non-volatile FEE devices by making EEPROM-style function calls to wrapper function 807, which can interface with hardware 803. From the perspective of file system 805 and application code 801, hardware 803 operates in a predictable, consistent manner regardless of which one or more specific devices it includes.

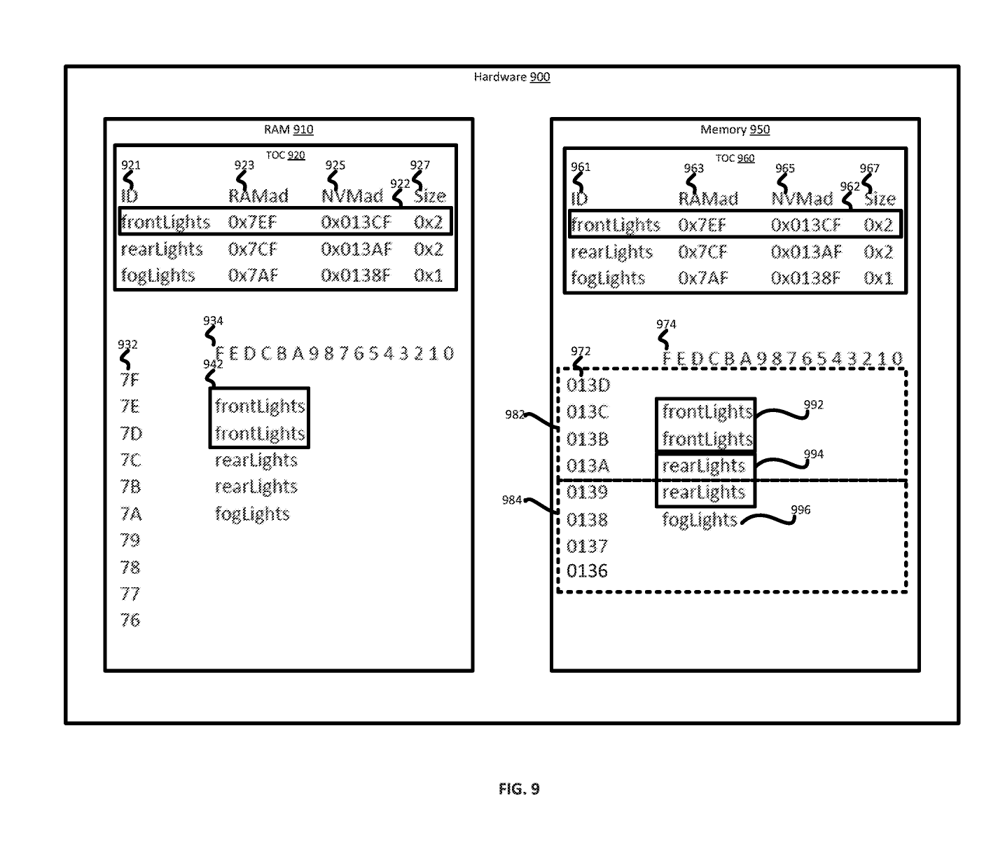

Including a FEE wrapper function in a computing system allows a file system designed for EEPROM devices to communicate seamlessly with an arbitrary FEE device. FIG. 9 illustrates an exemplary block diagram of computer hardware 900 with a file system in communication with a FEE wrapper function according to examples of the disclosure. Hardware 900 can include RAM 910 and memory 950. RAM 910 can store a table of contents 920 and additional data addressable by bits 934 and bytes 932. In some examples, memory 950 can include a FEE device, wherein data stored in a plurality of blocks 982 and 984 can be addressable by emulated bits 974 and bytes 972.

In some examples, RAM 910 can be faster and more expensive than non-volatile memory 950. Non-volatile memory 950 can retain data even when the power supply (not pictured) to the hardware 900 is disconnected, for example. Because RAM 910 and non-volatile memory 950 have different advantages and disadvantages, hardware 900 can use both levels of memory to have fast performance and inexpensive memory capable of saving data without a connected power supply.

In some examples, a file system can include hardware-agnostic functions for developers to call to use the file system, making their code compatible with a variety of non-volatile memory types. Including a FEE wrapper function (e.g., wrapper 807) in a computing system (e.g., computing system 800) can allow a file system (e.g., file system 805) itself to call hardware-agnostic functions to operate. For example, memory 950 can be a FEE device including memory addressable in “blocks”, such as blocks 992 and 994. In some examples, a FEE device can emulate EEPROM behavior by providing a mapping between emulated EEPROM addresses (such as bytes 972 and bits 974) to one or more blocks (such as blocks 992 and 994), though blocks may have to be read and written (e.g., by a function included in a FEE library or in a wrapper function) in their entirety. As an example, block 982 can store a data structure “frontLights” 992 and a first part of a data structure “rearLights” 994. Block 984 can store a second part of “rearLights” 994 and “fogLights” 996.

When the file system receives a command to read “frontLights” 992, all data stored in block 982 can be retrieved by the FEE wrapper function because in some examples, flash blocks of FEE devices may have to be loaded in their entirety. That is, bytes 972 and bits 974 may not be individually addressable directly from a FEE device included in memory 950. In accordance with EEPROM-like behavior (including the ability for the file system to individually address bytes 972 and bits 974), the FEE wrapper function can output “frontLights” 992 to the file system to be loaded into RAM 910. Although the FEE wrapper function can also load from the FEE device a first part of “rearLights” 994 because it is included in block 982, that data may not be output by the FEE wrapper function to the file system in response to the file system's request for only bytes 0x13C and 0x13B. In this way, the file system can input an EEPROM-style read command to the FEE wrapper to read bytes 0x013C and 0x013A without specifically requesting to read block 982, for example.

Similarly, although the data structure “rearLights” 994 can be a same size as “frontLights” 992 (e.g., they can each include two bytes of data), “rearLights” 994 can be partially stored in block 982 and partially stored in 984. When the file system receives a command to read “rearLights” 994, block 982 and block 984 can retrieved from the FEE device by the FEE wrapper function. In accordance with EEPROM-like behavior (including the ability for the file system to individually address bytes 972 and bits 974), the FEE wrapper function can output “rearLights” 994 to the file system to be loaded into RAM 910. Although FEE wrapper function can also load from the FEE device “frontLights” 992 and “fogLights” 996, these data may not be output by the FEE wrapper function to the file system in response to the file system's request for only bytes 0x013A and 0x0139. In this way, the file system can input an EEPROM-style read command to the FEE wrapper to read bytes 0x13A and 0x139 without specifically requesting to read data from blocks 982 and 984, for example.

Referring again to FIG. 8, by including FEE wrapper 807 in computing system 800, a file system 805 can be designed to make a same plurality of read/write commands to the FEE wrapper 807, regardless of which types of devices are included in hardware 803. For example, application code 801 and file system 805 can be written before a type of hardware 803 is selected. When a type of hardware 803 changes, the FEE wrapper function 807 can be updated to include logic to determine a type of hardware 803 and make the appropriate function calls to hardware 803 in response to received function calls from file system 805, without necessitating an updated file system.

Application code 801 can interact with file system 805 in a same manner as application code 301 can interact with file system 305, although file system 305 can make function calls to hardware 303 while file system 805 can make function calls to FEE wrapper 807. Operation of a file system included in hardware 900 will now be described with reference to FIG. 9. According to some examples of the disclosure, hardware 900 can use a file system capable of managing data in RAM 910 and non-volatile memory 950. The file system can include a table of contents, of which there may be a copy 920 saved in RAM 910 and/or a copy 960 saved in non-volatile memory 950. When the table of contents 920 stored in RAM 910 is updated, as will be described below, and then saved to non-volatile memory 950, both copies 920 and 960 can be identical. The table of contents 920 stored in RAM 910 can include entries, such as entry 922 that indicate where each data structure of the computing system is stored in RAM 910 and non-volatile memory 950, which will be described in more detail below. Likewise, for example, the table of contents 960 stored in non-volatile memory 960 of hardware 900 can include respective entry 962.

Entry 922 in table of contents 920 can include a unique ID 921, an address 923 of the data structure in RAM 910, an address 925 of the data structure in non-volatile memory 950, and the size 927 of the data structure, for example. Likewise, for example, entry 962 in table of contents 960 can include a unique ID 961, an address 963 of the data structure in RAM 910, an address 965 of the data structure in non-volatile memory 950, and the size 967 of the data structure. As shown in FIG. 9, for example, “frontLights” is stored at address 0x7EF in RAM 910 and emulated address 0x013CF in non-volatile memory 950. These addresses are reflected in entry 922 in table of contents 910 and entry 962 in table of contents 960. In some examples including one or more FEE devices functioning as memory 950, the table of contents can further include an address of one or more blocks corresponding to an emulated EEPROM-style address 965 of a data structure.

Some example tables of contents 920 and 960 may also include metadata (not pictured) for each entry. The metadata can include a version number and a time indicating when the entry was last saved to non-volatile memory. Some examples of the disclosure may, additionally or alternatively, have other kinds of metadata for each entry within a table of contents.

In some examples, a table of contents, such as table of contents 920 or table of contents 960 for example, can also include its own metadata (not pictured). This metadata can include an ID to indicate a location of table of contents in non-volatile memory, a version indicating the structure of the table of contents, a time indicating when the table of contents was created, and a time indicating when the table of contents was last saved to non-volatile memory. Some examples of the disclosure may, additionally or alternatively, have other kinds of metadata for a table of contents.

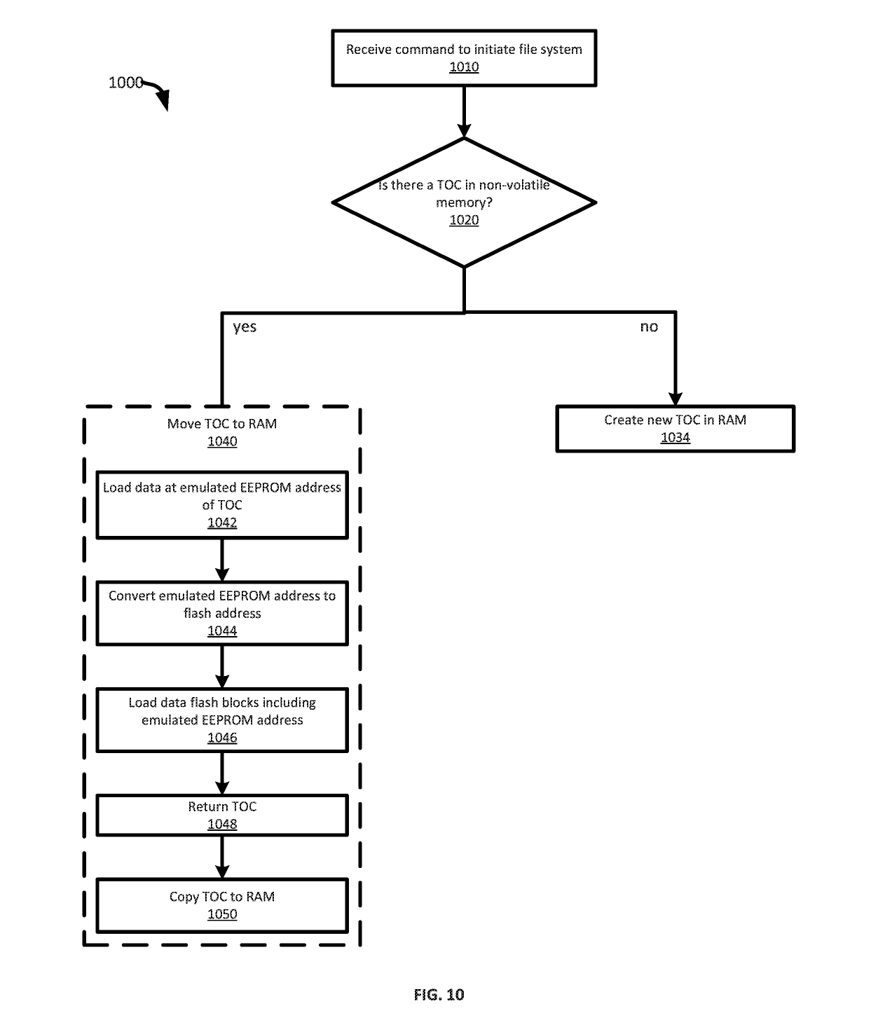

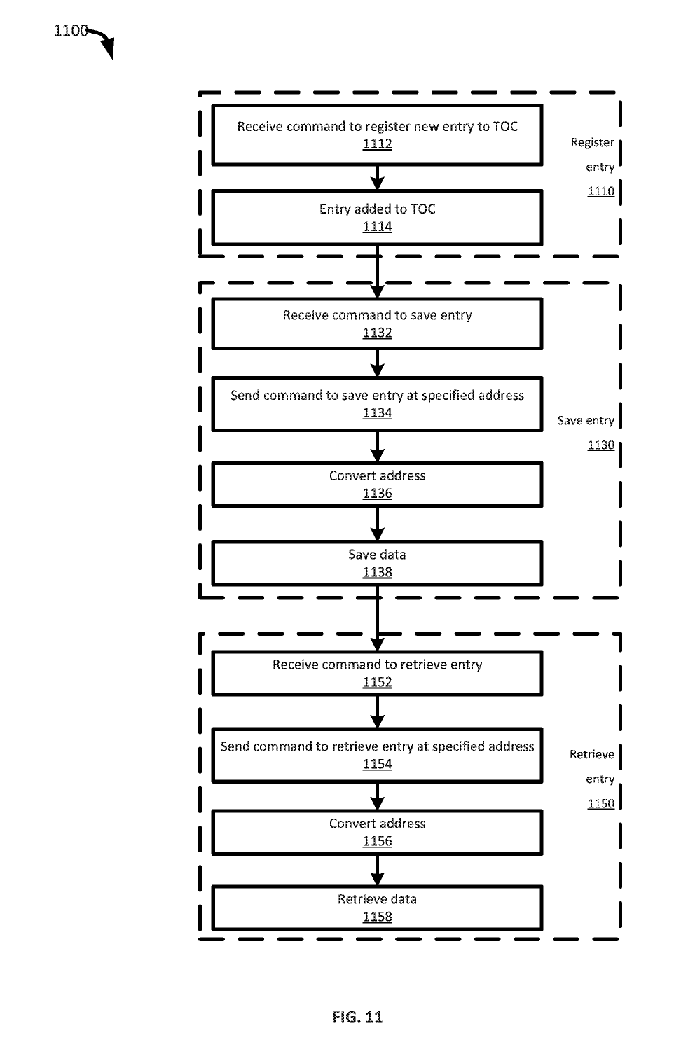

A file system according to examples of the disclosure can automatically manage where in RAM and non-volatile memory to a save data structure once that data structure is initiated. FIG. 10 illustrates an exemplary process 1000 for initiating a file system and loading or generating a table of contents 920 or 960 for the file system, according to examples of the disclosure. An application stored on a computing system can execute a command to initiate a file system (e.g., the command can originate in application code). Once the command is received 1010 at the file system, the computing system can check 1020 non-volatile memory 950 for an existing table of contents 960, for example. In some examples, a table of contents 960 and its entries may have been saved to non-volatile memory 950 before the computing system's power was disconnected. In some examples, when a table of contents 960 is found in non-volatile memory 950, it can be moved 1040 to RAM.

To move an existing TOC to RAM 1040, a file system can communicate with a FEE wrapper function to load the correct data, including converting an emulated EEPROM address to one or more blocks of memory of the FEE device, as will be described below. A file system can issue a command (1042) to the wrapper function to load data at an emulated EEPROM address at which a table of contents is stored. The FEE wrapper function can convert (1044) the EEPROM address to a flash address. The FEE wrapper function can also issue a command to a FEE device to load (1046) the requested blocks of memory. The FEE wrapper function can return (1048) to the file system the table of contents. In some examples, the FEE wrapper function can receive additional data while loading the flash blocks including the table of contents 960, but can only return to the file system the table of contents 960. The file system can copy (1050) the table of contents 960 into RAM 920. In some examples, when no table of contents is found in memory 950, a new table of contents 910 or 960 can be created 1034. Once the table of contents 960 is moved 1040 to RAM 910, or table of contents 920 is created 1034 in RAM 910, it can be read and edited by the computing system to manage data, according to examples of the disclosure.

In some examples, once a table of contents 920 is in RAM 910, the computing system can use the file system to manage data. FIG. 11 illustrates an exemplary process 1100 for managing a data structure including registering an entry 1110, saving an entry 1130, and retrieving an entry 1150 using a file system, according to examples of the disclosure. For data to be managed by the file system, it can be registered 1110 with a table of contents, for example.

In some examples, registering 1110 an entry can include storing an ID 921 or 961 of the data structure, its size 927 or 967, and its address in RAM 923 or 963 and/or its address in memory 925 or 965 in a table of contents 910 or 950. In some examples, an application executed by the computing system can include a command to register an entry to a table of contents of a file system. The command can include a unique ID 921 or 962 for the entry, the size 927 or 967 of the data structure, and a version number (not shown), for example. When the command is received 1112 at the file system, the entry can be added to the table of contents 1114 and managed by the file system according to examples of the disclosure.

In some examples, space in RAM 910 and non-volatile memory 950 can be allocated for each entry at the time it is registered. In some examples, space in RAM 910 and non-volatile memory 950 can be dynamically allocated as needed. In some examples, when an entry is registered to the table of contents 920 or 960, the entry may not include an address 925 or 926 in non-volatile memory 950 until the application code executes a command to perform a save operation 1130 to save the corresponding data, as described below. Additionally or alternatively, in some examples, data stored in non-volatile memory 950 may not have a RAM address 923 or 963 associated therewith until it is loaded 1150 from non-volatile memory 950, as described below. Examples of saving and loading data with a file system according to examples of the disclosure will now be described.

In some examples, after registering entries, as described above, the file system can save 1130 registered entries to non-volatile memory 950. Saving data to non-volatile memory 950, as discussed above, can have the advantages of protecting it in the event of a power outage and/or creating more space in RAM 910 for data that may need to be edited, for example. An application executed by the computing system according to examples of the disclosure can modify data associated with a registered entry and then execute a command to save the data to non-volatile memory 950. The file system can receive 1132 a command to save an data corresponding to an entry in a table of contents 920 or 960 to non-volatile memory 950. The file system can in turn send a command 1134 to a FEE wrapper to save the data corresponding to the entry at a specified emulated EEPROM address. In response, the FEE wrapper can convert 1136 the address to an address of the one or more blocks including the specified address. The entry can be saved 1138 to the specified location without editing or overwriting any other data included in the one or more blocks in which the entry is saved.

In some examples, to write data to a block, the whole block can be re-written. One or more of a FEE library and a FEE wrapper function can be configured to re-write a block including an updated version of the data structure for which the save command was received. In a same operation, the FEE wrapper can re-write an existing version of one or more additional data structures stored in the block. The whole re-written block can be saved.

In some examples, an entry may have space allocated for it in non-volatile memory 950 when it is registered. That is, there may be space in non-volatile memory 950 allocated for data that has not yet been saved to non-volatile memory 950, for example. In some examples, an entry may not have space allocated for it in non-volatile memory 950 when it is registered. That is, an entry's address 925 or 965 in non-volatile memory 950 may not be included in the table of contents 920 or 960 until the data corresponding to the entry has been saved to non-volatile memory 950, for example.

In some examples, once an entry is registered 1110 with a table of contents 920 or 960 and saved 1130 to non-volatile memory 950, the data corresponding to the entry can be retrieved 1150 from non-volatile memory 950 and loaded into RAM 910. Loading data into RAM 910, as discussed above, can have the advantages of quick access and editing, for example. In some examples, an application executed by the computing system can retrieve data to be edited or otherwise used by the computing system by executing a command. The file system can receive 1152 a command to retrieve an entry at a specified emulated EEPROM address. The file system can in turn send 1154 a command to the FEE wrapper function to retrieve data at the specified emulated EEPROM address. The FEE wrapper function can convert 1156 the emulated EEPROM address to an address of one or more blocks in flash memory including the specified data. The FEE wrapper function can retrieve 1158 the data, including any other data included in the flash blocks including the entry, but only return the requested data to the file system to be loaded into RAM.

In some examples, an address 923 or 963 in RAM may be allocated for data before a command to retrieve the entry's data is received at the file system. That is, the table of contents 920 or 960 may already include an assigned address 923 or 963 in RAM 910 for an entry before it is retrieved, for example. In some examples, an address 923 or 963 in RAM 910 may be allocated for an entry when a command to retrieve the entry's data is received. That is, an entry's address 923 or 963 in RAM 910 may not be included in the table of contents 920 or 960 until the data associated with the entry has been loaded into RAM 910, for example. According to examples of the disclosure, an entry can be retrieved as long as it is registered to the table of contents 920 or 960 and its data is saved to non-volatile memory 960. For example, if a computing system has not saved or otherwise edited data using its RAM 910 since powering on, it can access data saved to non-volatile memory 960 during a previous use by retrieving it from non-volatile memory 950.

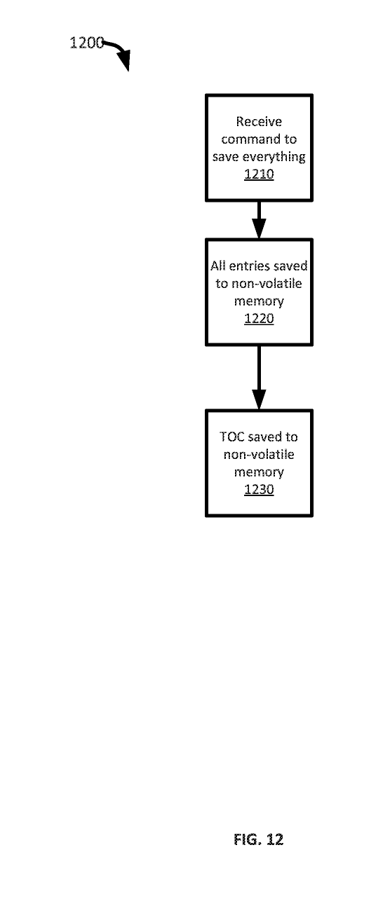

In some examples, when data is being saved to non-volatile memory 950, an interruption such as a power outage or other error can corrupt the data. In a safety-critical system such as a vehicle ECU, it may be important for saves only to occur when there is enough time to reliably complete the process uninterrupted, for example. Therefore, some examples of the disclosure only save data to non-volatile memory 950 when a command to save is received from the user or when the system otherwise detects there is sufficient time to execute the save. In some examples, to preserve the table of contents 920 and all data currently stored in RAM 910, everything can be saved to non-volatile memory 950 before the power supply (not shown) is disconnected. FIG. 12 illustrates an exemplary process 1200 for saving all entries and the table of contents to non-volatile storage using a file system, according to examples of the disclosure. The file system can receive (e.g., from application code) a command to save 1210 everything, for example. Then, all entries can be saved 1220 to non-volatile memory 950 according to steps 1130-1138 described with reference to FIG. 11. The table of contents can also be saved 1130 to non-volatile memory in a similar manner, for example. In some examples, steps 1120 and 1130 may be performed in any order or concurrently according to various examples of the disclosure.

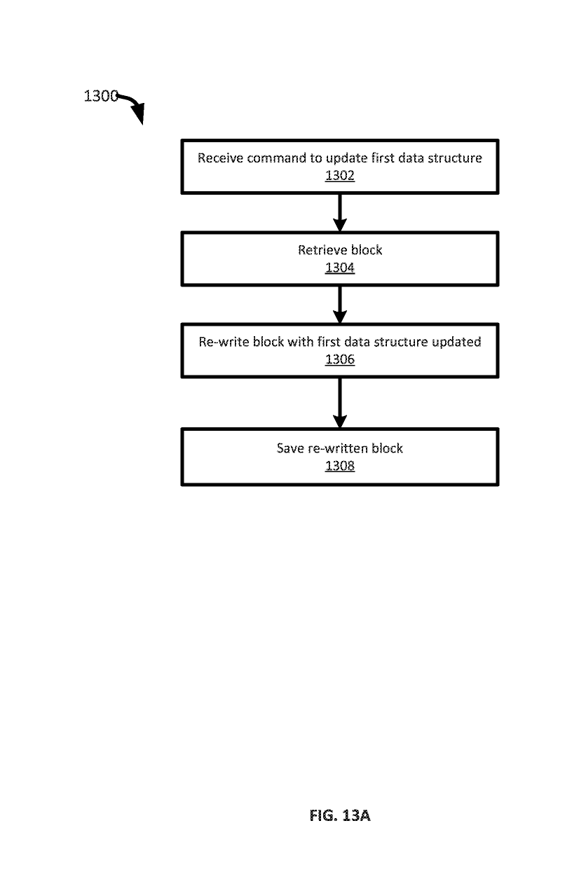

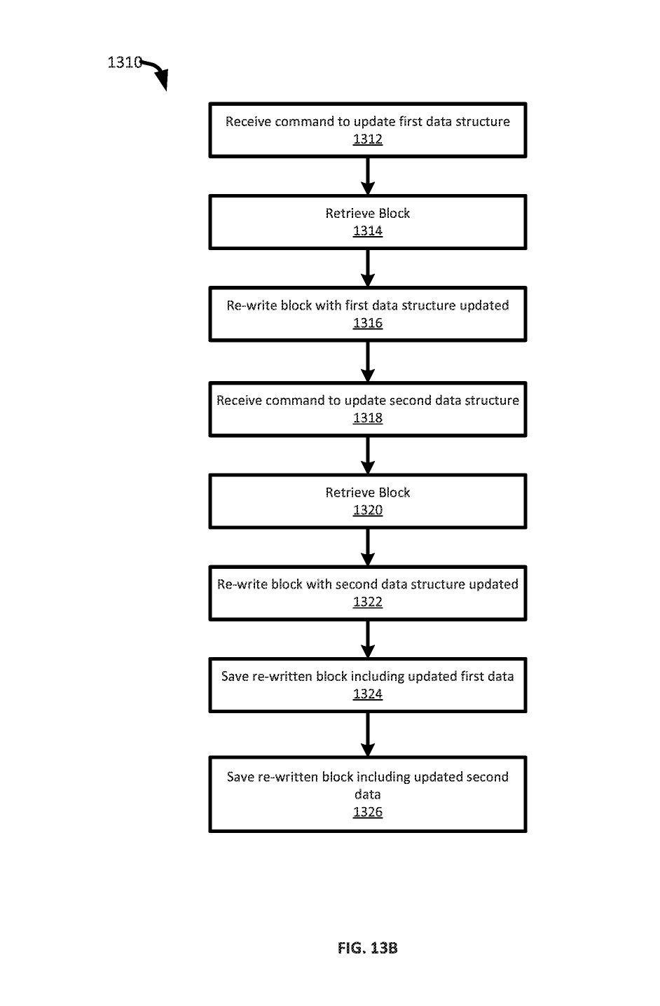

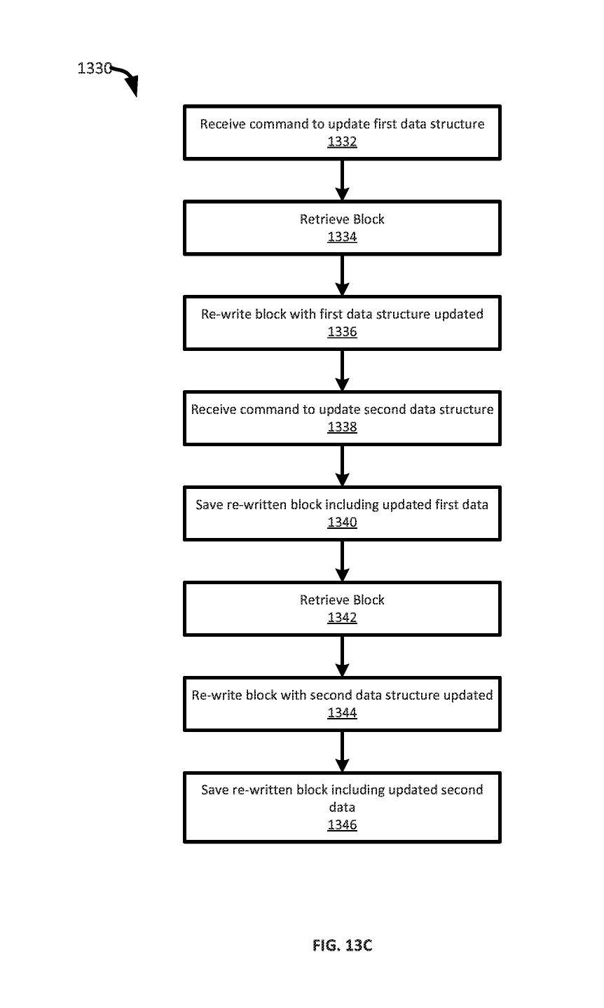

To update data stored on a FEE device, whole blocks of flash memory can be re-written, even when just one data structure of a plurality of data structures residing on a given block is to be updated. In some examples, a FEE wrapper can include a queue for asynchronous read/write operations, thus preventing more than one of these operations from occurring at a time to protect data from being inadvertently overwritten or erased. For example, any one or more substeps of saving 1130 and retrieving 1150 an entry in non-volatile memory can include queuing the save or load operation. The save or load operation may not commence while another save or load operation is taking place. This queuing behavior can avoid inadvertently overwriting and/or erasing all or part of a data structure. FIGS. 13A-13C illustrate exemplary processes of storing data using a wrapper function according to examples of the disclosure.

FIG. 13A illustrates an exemplary process 1300 for updating a data structure. A FEE device can receive a command (e.g., from a file system, from application code, or from a wrapper function) to update (1302) a first data structure residing on a block of flash memory, for example. The block can be retrieved (1304) including the first data structure and, in some examples, additional data not part of the first data structure. The block can be re-written (1306) including updates to the first data structure. The block can then be saved (1308) to the device. Accordingly, the first data structure can be updated and any other data stored on the block can remain in a same state as it was in prior to when the command to update the first data structure was received at step 1302.

FIG. 13B illustrates an exemplary process 1310 for updating multiple data structures residing on a same block according to examples of the disclosure. A FEE device can receive (e.g., from application code, a file system, and/or a wrapper function) (1312) a command to update a first data structure residing on a block of flash memory. The block can be retrieved (1314). Next, the block can be re-written (1316) including updates to the first data structure. Meanwhile, the FEE device can receive (1318) a second command to update a second data structure residing on the same block. The block, as it exists in an unedited state stored on the device, can be retrieved (1320). Next, the block can be re-written including updates to the second data structure (1322). The operation to update the first data structure can continue, saving (1324) the re-written block including updates to the first data structure to the device. Next, the operation to update the second data structure can continue, saving the re-written block including updates to the second data structure to the device (1326).

Because the operation to update the second data structure began before the operation to update the first data structure was completed, updates to the first data structure can be inadvertently overwritten during process 1310. Although the updated first data structure can be saved to the FEE device in step 1324, the re-written block including the updated second data can include the original first data structure because it was retrieved in step 1320 before the updated first data structure was saved. Similar issues can arise when performing one or more operations to load data, for example. In some examples, it can be advantageous to complete each save or load before starting a second save or load using a FEE wrapper with an asynchronous read/write queue.

FIG. 13C illustrates an exemplary process for updating multiple data structures residing on a same block according to examples of the disclosure. A FEE device can receive (1332) a command to update a first data structure residing on a block of flash memory. The block can be retrieved (1334). Next, the block can be re-written (1336) including updates to the first data structure. Meanwhile, the FEE device can receive (1338) a second command to update a second data structure residing on the same block. Rather than beginning to update the second data structure, process 1330 can first complete the operation for updating the first data structure. The re-written block including updates to the first data structure can be saved (1340). The updated block can be retrieved (1342). Next, the block can be re-written including updates to the second data structure (1344). Next, the re-written block including updates to the second data structure can be saved (1346). Accordingly, both the first and the second data structures can be updated, as the updates to the first data structure can be written to the block before it is retrieved to write updates to the second data structure.

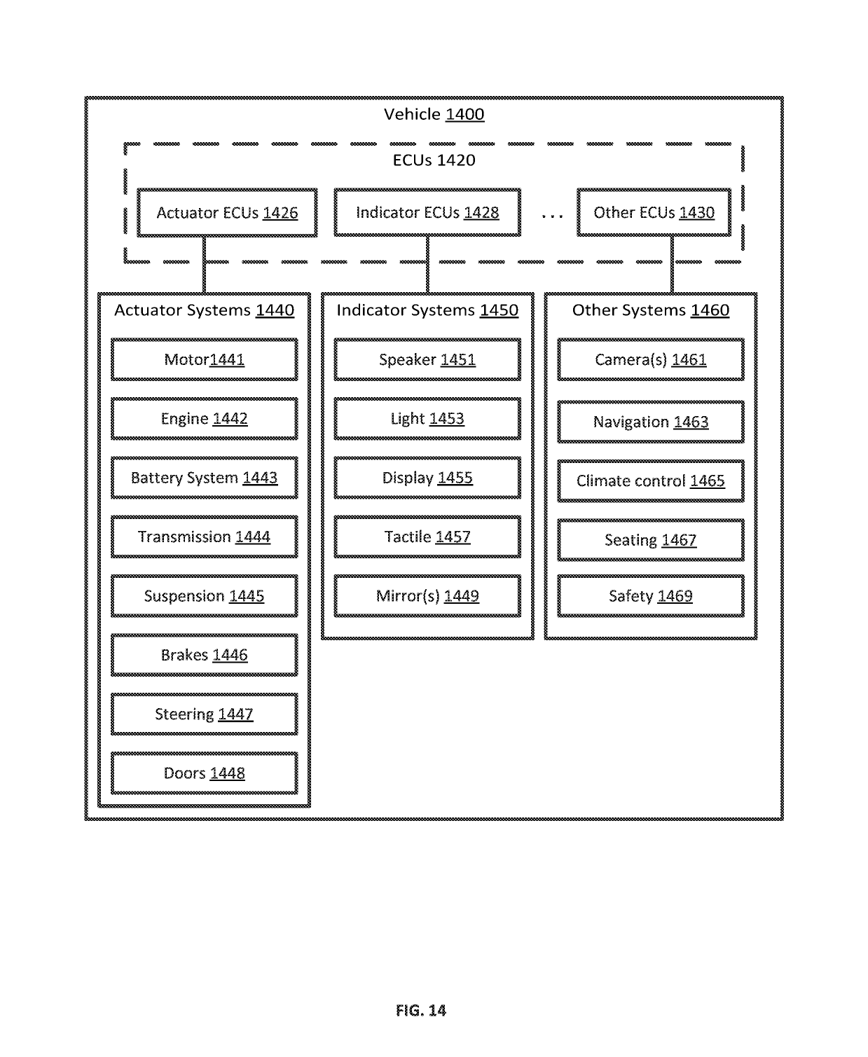

One or more ECUs optionally including one or more of application code, a file system, a wrapper function, and hardware according to examples of the disclosure can be incorporated into a consumer automobile. FIG. 14 illustrates a block diagram of an exemplary vehicle 1400 including a plurality of ECUs 1420 according to examples of the disclosure. ECUs 1420 can include actuator ECUs 1426, indicator ECUs 1428, and other ECUs 1430. Vehicle 1400 can further include one or more actuator systems 1440, indicator systems 1450, and other systems 1460 operatively coupled to one or more respective ECUs 1420. Actuator systems 1440 can include a motor 1441, an engine 1442, a battery system 1443, transmission gearing 1444, suspension setup 1445, brakes 1446, steering 1447, and doors 1448. Indicator systems 1450 can include one or more speakers 1451, one or more lights 1453, one or more displays 1455, one or more tactile indicators 1457, and one or more mirrors 1449. In some examples, other systems 1460 can include one or more cameras 1461, navigation 1463, climate control 1465, seating 1467, and one or more safety systems 1469.

In some examples, one or more systems within actuator systems 1440, indicator systems 1450, and other systems 1460 can be operatively coupled to one or more respective ECUs 1420. For example, a motor ECU (not shown) can control one or more functions of motor 1441. A speaker ECU (not shown) can control one or more functions of speaker 1451. Other systems shown and not shown here can be controlled by one or more respective ECUs to perform one or more functions. In some examples, one or more ECUs can include a computing system according to the examples described with reference to FIGS. 1-13. In some examples, vehicle 1400 can include additional ECUs, systems, and other components. For example, vehicle 1400 can include additional computing devices, such as processors, controllers, and storage/memory.

Therefore, according to the above, some examples of the disclosure are directed to a method of managing data in an electronic control unit of a vehicle including volatile and non-volatile memory, the method comprising: at the electronic control unit of the vehicle: retrieving a table of contents from the non-volatile memory including a plurality of entries, each respective entry of the plurality of entries including a respective address in the non-volatile memory where respective data associated with the respective entry is stored; and in response to receiving one or more requests associated with a first entry of the plurality of entries, the one or more requests originating in application code of the electronic control unit: loading first data associated with the first entry from a first address in the non-volatile memory to a second address in the volatile memory, and storing the second address in the first entry of the plurality of entries of the table of contents. Additionally or alternatively to one or more of the examples disclosed above, the method further includes upon powering on the electronic control unit, determining whether the table of contents is stored on the non-volatile memory; and in accordance with the table of contents not being stored on the non-volatile memory, creating the table of contents, including in response to receiving a plurality of entry creation requests originating in the application code of the electronic control unit, creating a respective entry in the table of contents for each of the plurality of entry requests, and assigning a respective address in non-volatile memory to the respective entry in the table of contents. Additionally or alternatively to one or more of the examples disclosed above, the method further comprises in response to receiving one or more initialization requests, originating in the application code of the electronic control unit, for each respective entry of the plurality of entries in the retrieved table of contents: loading respective data associated with the respective entry from the non-volatile memory to a respective address in the volatile memory, and storing the respective address in the respective entry of the plurality of entries of the table of contents. Additionally or alternatively to one or more of the examples disclosed above, the method further comprises in response to receiving one or more shutdown requests, loading data associated with selected entries of the table of contents from the volatile memory to the non-volatile memory. Additionally or alternatively to one or more of the examples disclosed above, the method further comprises in response to receiving a request to load second data from the volatile memory to the non-volatile memory, the request originating in the application code of the electronic control unit, determining a hardware type of the non-volatile memory, determining a third address in the non-volatile memory at which to load the second data, the third address in a first domain, converting the third address to a second domain in accordance with the hardware type of the non-volatile memory, and writing the second data to the non-volatile memory in accordance with the hardware type of the non-volatile memory. Additionally or alternatively to one or more of the examples disclosed above, a location in the non-volatile memory associated with the third address in the second domain further comprises third data, and writing the second data to the non-volatile memory comprises re-writing the third data. Additionally or alternatively to one or more of the examples disclosed above, the method further comprises while performing any one of determining the hardware type, determining the third address, converting the third address, and writing to the non-volatile memory, receiving a request to load third data from volatile memory to non-volatile memory, and in response to the request to load the third data from volatile memory to non-volatile memory: waiting until writing the second data to the non-volatile memory is complete, and after waiting until writing the second data is complete, determining a fourth address in the non-volatile memory at which to load the third data; and writing the third data to the non-volatile memory.

Some examples of the disclosure are related to a non-transitory computer-readable storage medium storing instructions that, when executed by one or more processors of an electronic control unit of a vehicle, causes the electronic control unit to perform a method of managing data in the electronic control unit including volatile and non-volatile memory, the method comprising: at the electronic control unit of the vehicle: retrieving a table of contents from the non-volatile memory including a plurality of entries, each respective entry of the plurality of entries including a respective address in the non-volatile memory where respective data associated with the respective entry is stored; and in response to receiving one or more requests associated with a first entry of the plurality of entries, the one or more requests originating in application code of the electronic control unit, loading first data associated with the first entry from a first address in the non-volatile memory to a second address in the volatile memory, and storing the second address in the first entry of the plurality of entries of the table of contents. Additionally or alternatively to one or more of the examples disclosed above, the method further comprises determining whether the table of contents is stored on the non-volatile memory; and in accordance with the table of contents not being stored on the non-volatile memory, creating the table of contents, including in response to a plurality of entry creation requests originating in the application code of the electronic control unit, creating a respective entry in the table of contents for each of the plurality of entry requests, and assigning a respective address in non-volatile memory to the respective entry in the table of contents. Additionally or alternatively to one or more of the examples disclosed above, the method further comprises in response to receiving one or more initialization requests, originating in the application code of the electronic control unit, for each respective entry of the plurality of entries in the retrieved table of contents: loading respective data associated with the respective entry from the non-volatile memory to a respective address in the volatile memory, and storing the respective address in the respective entry of the plurality of entries of the table of contents. Additionally or alternatively to one or more of the examples disclosed above, the method further comprises in response to receiving one or more shutdown requests, loading data associated with selected entries of the table of contents from the volatile memory to the non-volatile memory. Additionally or alternatively to one or more of the examples disclosed above, the method further comprises in response to receiving a request to load second data from the volatile memory to the non-volatile memory, the request originating in the application code of the electronic control unit: determining a hardware type of the non-volatile memory, determining a third address in the non-volatile memory at which to load the second data, the third address in a first domain, converting the third address to a second domain in accordance with the hardware type of the non-volatile memory, and writing the second data to the non-volatile memory in accordance with the hardware type of the non-volatile memory. Additionally or alternatively to one or more of the examples disclosed above, a location in the non-volatile memory associated with the third address in the second domain further comprises third data, and writing the second data to the non-volatile memory comprises re-writing the third data. Additionally or alternatively to one or more of the examples disclosed above, the method further comprises while performing any one of determining the hardware type, determining the third address, converting the third address, and writing to the non-volatile memory, receiving a request to load third data from volatile memory to non-volatile memory, and in response to the request to load the third data from volatile memory to non-volatile memory: waiting until writing the second data to the non-volatile memory is complete, and after waiting until writing the second data is complete: determining a fourth address in the non-volatile memory at which to load the third data; and writing the third data to the non-volatile memory.

Some examples of the disclosure are related to a vehicle comprising an electronic control unit, the electronic control unit configured for retrieving a table of contents from the non-volatile memory including a plurality of entries, each respective entry of the plurality of entries including a respective address in the non-volatile memory where respective data associated with the respective entry is stored; and in response to receiving one or more requests associated with a first entry of the plurality of entries, the one or more requests originating in application code of the electronic control unit: loading first data associated with the first entry from a first address in the non-volatile memory to a second address in the volatile memory, and storing the second address in the first entry of the plurality of entries of the table of contents. Additionally or alternatively to one or more of the examples disclosed above, the electronic control unit is further configured for: upon powering on the electronic control unit, determining whether the table of contents is stored on the non-volatile memory; and in accordance with the table of contents not being stored on the non-volatile memory, creating the table of contents, including: in response to receiving a plurality of entry creation requests originating in the application code of the electronic control unit, creating a respective entry in the table of contents for each of the plurality of entry requests, and assigning a respective address in non-volatile memory to the respective entry in the table of contents. Additionally or alternatively to one or more of the examples disclosed above, the electronic control unit is further configured for: in response to receiving one or more initialization requests, originating in the application code of the electronic control unit, for each respective entry of the plurality of entries in the retrieved table of contents: loading respective data associated with the respective entry from the non-volatile memory to a respective address in the volatile memory, and storing the respective address in the respective entry of the plurality of entries of the table of contents. Additionally or alternatively to one or more of the examples disclosed above, the electronic control unit is further configured for: in response to receiving a request to load second data from the volatile memory to the non-volatile memory, the request originating in the application code of the electronic control unit: determining a hardware type of the non-volatile memory, determining a third address in the non-volatile memory at which to load the second data, the third address in a first domain, converting the third address to a second domain in accordance with the hardware type of the non-volatile memory, and writing the second data to the non-volatile memory in accordance with the hardware type of the non-volatile memory. Additionally or alternatively to one or more of the examples disclosed above, a location in the non-volatile memory associated with the third address in the second domain further comprises third data, and writing the second data to the non-volatile memory comprises re-writing the third data. Additionally or alternatively to one or more of the examples disclosed above, the electronic control unit is further configured for: while performing any one of determining the hardware type, determining the third address, converting the third address, and writing to the non-volatile memory, receiving a request to load third data from volatile memory to non-volatile memory, and in response to the request to load the third data from volatile memory to non-volatile memory: waiting until writing the second data to the non-volatile memory is complete, and after waiting until writing the second data is complete: determining a fourth address in the non-volatile memory at which to load the third data; and writing the third data to the non-volatile memory.

Although examples have been fully described with reference to the accompanying drawings, it is to be noted that various changes and modifications will become apparent to those skilled in the art. Such changes and modifications are to be understood as being included within the scope of examples of this disclosure as defined by the appended claims.

1. A method of managing data in an electronic control unit of a vehicle including volatile and non-volatile memory, the method comprising:
at the electronic control unit of the vehicle:
retrieving a table of contents from the non-volatile memory including a plurality of entries, each respective entry of the plurality of entries including a respective address in the non-volatile memory where respective data associated with the respective entry is stored; and
in response to receiving one or more requests associated with a first entry of the plurality of entries, the one or more requests originating in application code of the electronic control unit:
loading first data associated with the first entry from a first address in the non-volatile memory to a second address in the volatile memory, and
storing the second address in the first entry of the plurality of entries of the table of contents.

2. The method of claim 1, the method further comprising:
upon powering on the electronic control unit, determining whether the table of contents is stored on the non-volatile memory; and
in accordance with the table of contents not being stored on the non-volatile memory, creating the table of contents, including:
in response to receiving a plurality of entry creation requests originating in the application code of the electronic control unit, creating a respective entry in the table of contents for each of the plurality of entry requests, and assigning a respective address in non-volatile memory to the respective entry in the table of contents.

3. The method of claim 1, the method further comprising:
in response to receiving one or more initialization requests, originating in the application code of the electronic control unit, for each respective entry of the plurality of entries in the retrieved table of contents:
loading respective data associated with the respective entry from the non-volatile memory to a respective address in the volatile memory, and
storing the respective address in the respective entry of the plurality of entries of the table of contents.

4. The method of claim 1, the method further comprising:
in response to receiving one or more shutdown requests, loading data associated with selected entries of the table of contents from the volatile memory to the non-volatile memory.

5. The method of claim 1, the method further comprising:
in response to receiving a request to load second data from the volatile memory to the non-volatile memory, the request originating in the application code of the electronic control unit:
determining a hardware type of the non-volatile memory,
determining a third address in the non-volatile memory at which to load the second data, the third address in a first domain,
converting the third address to a second domain in accordance with the hardware type of the non-volatile memory, and
writing the second data to the non-volatile memory in accordance with the hardware type of the non-volatile memory.

6. The method of claim 5, wherein a location in the non-volatile memory associated with the third address in the second domain further comprises third data, and writing the second data to the non-volatile memory comprises re-writing the third data.

7. The method of claim 5, the method further comprising:
while performing any one of determining the hardware type, determining the third address, converting the third address, and writing to the non-volatile memory, receiving a request to load third data from volatile memory to non-volatile memory, and
in response to the request to load the third data from volatile memory to non-volatile memory:
waiting until writing the second data to the non-volatile memory is complete, and after waiting until writing the second data is complete:
determining a fourth address in the non-volatile memory at which to load the third data; and
writing the third data to the non-volatile memory.

8. A non-transitory computer-readable storage medium storing instructions that, when executed by one or more processors of an electronic control unit of a vehicle, causes the electronic control unit to perform a method of managing data in the electronic control unit including volatile and non-volatile memory, the method comprising:
at the electronic control unit of the vehicle:
retrieving a table of contents from the non-volatile memory including a plurality of entries, each respective entry of the plurality of entries including a respective address in the non-volatile memory where respective data associated with the respective entry is stored; and
in response to receiving one or more requests associated with a first entry of the plurality of entries, the one or more requests originating in application code of the electronic control unit:
loading first data associated with the first entry from a first address in the non-volatile memory to a second address in the volatile memory, and
storing the second address in the first entry of the plurality of entries of the table of contents.

9. The non-transitory computer-readable storage medium of claim 8, the method further comprising:
determining whether the table of contents is stored on the non-volatile memory; and
in accordance with the table of contents not being stored on the non-volatile memory, creating the table of contents, including:
in response to a plurality of entry creation requests originating in the application code of the electronic control unit, creating a respective entry in the table of contents for each of the plurality of entry requests, and assigning a respective address in non-volatile memory to the respective entry in the table of contents.

10. The non-transitory computer-readable storage medium of claim 8, the method further comprising:
in response to receiving one or more initialization requests, originating in the application code of the electronic control unit, for each respective entry of the plurality of entries in the retrieved table of contents:
loading respective data associated with the respective entry from the non-volatile memory to a respective address in the volatile memory, and
storing the respective address in the respective entry of the plurality of entries of the table of contents.

11. The non-transitory computer-readable storage medium of claim 8, the method further comprising:
in response to receiving one or more shutdown requests, loading data associated with selected entries of the table of contents from the volatile memory to the non-volatile memory.

12. The non-transitory computer-readable storage medium of claim 8, the method further comprising:
in response to receiving a request to load second data from the volatile memory to the non-volatile memory, the request originating in the application code of the electronic control unit:
determining a hardware type of the non-volatile memory,
determining a third address in the non-volatile memory at which to load the second data, the third address in a first domain,
converting the third address to a second domain in accordance with the hardware type of the non-volatile memory, and
writing the second data to the non-volatile memory in accordance with the hardware type of the non-volatile memory.

13. The non-transitory computer-readable storage medium of claim 12, wherein a location in the non-volatile memory associated with the third address in the second domain further comprises third data, and writing the second data to the non-volatile memory comprises re-writing the third data.

14. The non-transitory computer-readable storage medium of claim 12, the method further comprising:
while performing any one of determining the hardware type, determining the third address, converting the third address, and writing to the non-volatile memory, receiving a request to load third data from volatile memory to non-volatile memory, and
in response to the request to load the third data from volatile memory to non-volatile memory:
waiting until writing the second data to the non-volatile memory is complete, and
after waiting until writing the second data is complete:
determining a fourth address in the non-volatile memory at which to load the third data; and
writing the third data to the non-volatile memory.

15. A vehicle comprising an electronic control unit, the electronic control unit configured for:
retrieving a table of contents from the non-volatile memory including a plurality of entries, each respective entry of the plurality of entries including a respective address in the non-volatile memory where respective data associated with the respective entry is stored; and
in response to receiving one or more requests associated with a first entry of the plurality of entries, the one or more requests originating in application code of the electronic control unit:
loading first data associated with the first entry from a first address in the non-volatile memory to a second address in the volatile memory, and
storing the second address in the first entry of the plurality of entries of the table of contents.

16. The vehicle of claim 15, wherein the electronic control unit is further configured for:
upon powering on the electronic control unit, determining whether the table of contents is stored on the non-volatile memory; and
in accordance with the table of contents not being stored on the non-volatile memory, creating the table of contents, including:
in response to receiving a plurality of entry creation requests originating in the application code of the electronic control unit, creating a respective entry in the table of contents for each of the plurality of entry requests, and assigning a respective address in non-volatile memory to the respective entry in the table of contents.

17. The vehicle of claim 15, wherein the electronic control unit is further configured for:
in response to receiving one or more initialization requests, originating in the application code of the electronic control unit, for each respective entry of the plurality of entries in the retrieved table of contents:
loading respective data associated with the respective entry from the non-volatile memory to a respective address in the volatile memory, and
storing the respective address in the respective entry of the plurality of entries of the table of contents.

18. The vehicle of claim 15, wherein the electronic control unit is further configured for:
in response to receiving a request to load second data from the volatile memory to the non-volatile memory, the request originating in the application code of the electronic control unit:
determining a hardware type of the non-volatile memory,
determining a third address in the non-volatile memory at which to load the second data, the third address in a first domain,
converting the third address to a second domain in accordance with the hardware type of the non-volatile memory, and
writing the second data to the non-volatile memory in accordance with the hardware type of the non-volatile memory.

19. The vehicle of claim 15, wherein a location in the non-volatile memory associated with the third address in the second domain further comprises third data, and writing the second data to the non-volatile memory comprises re-writing the third data.

20. The vehicle of claim 15, wherein the electronic control unit is further configured for:
while performing any one of determining the hardware type, determining the third address, converting the third address, and writing to the non-volatile memory, receiving a request to load third data from volatile memory to non-volatile memory, and
in response to the request to load the third data from volatile memory to non-volatile memory:
waiting until writing the second data to the non-volatile memory is complete, and
after waiting until writing the second data is complete:
determining a fourth address in the non-volatile memory at which to load the third data; and
writing the third data to the non-volatile memory.
